(19) United States
(12) Patent Application Publication
(10) Pub. No.: US 2026/0304186 A1
(43) Pub. Date: Oct. 1, 2026

(54) INFORMATION PROCESSING DEVICE, INFORMATION PROCESSING METHOD, AND NON-TRANSITORY COMPUTER-READABLE MEDIUM

(71) Applicant: NEC Corporation, Tokyo (JP)

(72) Inventor: Yoshiaki NISHIKAWA, Tokyo (JP)

(73) Assignee: NEC Corporation, Tokyo (JP)

(21) Appl. No.: 19/477,903

(22) PCT Filed: May 9, 2023
(86) PCT No.: PCT/JP2023/017436

§ 371 Date: Oct. 23, 2025

(51) Int. Cl. H04W 24/10

(52) U.S. Cl. CPC H04W 24/10

(57) ABSTRACT

An information processing device is provided with: a generation unit that generates a first radio quality distribution in the prescribed space by using the radio quality of each of the first division spaces, and generates a second radio quality distribution in the prescribed space by using the radio quality of each of the second division spaces; a change unit that changes a second division number to a third division number larger than the second division number on the basis of difference information indicating a radio quality difference between the second radio quality distribution and the first radio quality distribution; and an update unit that updates the second radio quality distribution to a third radio quality distribution by using the radio quality of each of the third division number of third division spaces.

### TECHNICAL FIELD

The present disclosure relates to an information processing device, an information processing method, and a non-transitory computer-readable medium.

### BACKGROUND ART

Wireless communication using radio waves is utilized in various fields, and reception power at the time of receiving radio waves is one of important factors in evaluating the quality of wireless communication. For example, to evaluate the quality of wireless communication in a certain area, a reception power distribution may sometimes be created. The reception power distribution refers to a distribution of reception power in a certain area, and visualizing the distribution of reception power makes it easy to spatially infer the quality of wireless communication.

PTL 1 discloses a configuration of a radio field intensity estimation device that calculates simulated radio field intensity, using a theoretical model of radio wave propagation at each position in a target space. Each position in the target space is, for example, each point of a grid obtained by segmenting a quadrilateral area into a grid pattern. The radio field intensity estimation device generates a learning model by learning the simulated radio field intensity at each point of the grid. The radio field intensity estimation device further estimates the radio field intensity at a target position from the observed radio field intensity, using the learning model.

### CITATION LIST

### Patent Literature

PTL 1: JP 2021-170738 A

### SUMMARY OF INVENTION

### Technical Problems

In PTL 1, a position for calculating the simulated radio field intensity is determined in advance. Therefore, in a case where the simulated radio field intensity is calculated again if a shielding object has been newly installed in the target space or if the position of a signal transmission source has been changed, it is necessary to repeat the calculation of the simulated radio field intensity for a number of positions determined in advance, and a large amount of calculation has become a difficulty.

In view of the above-described problems, an object of the present disclosure is to provide an information processing device, an information processing method, and a non-transitory computer-readable medium capable of suppressing an increase in the amount of calculation.

### Solution to Problem

An information processing device according to a first aspect of the present disclosure includes a generation unit for generating, for a predetermined space formed from a plurality of first divided spaces, a first radio quality distribution in the predetermined space by using radio quality of each of the first divided spaces, and generating, for the predetermined space formed from a plurality of second divided spaces larger than the first divided spaces, a second radio quality distribution in the predetermined space by using radio quality of each of the second divided spaces, a change unit for changing the second divided spaces to third divided spaces smaller than the second divided spaces, based on first difference information indicating a difference in radio quality between the second radio quality distribution and the first radio quality distribution, and an update unit for updating the second radio quality distribution to a third radio quality distribution by using radio quality of each of the third divided spaces.

An information processing method according to a second aspect of the present disclosure includes generating, for a predetermined space formed from a plurality of first divided spaces, a first radio quality distribution in the predetermined space by using radio quality of each of the first divided spaces, and generating, for the predetermined space formed from a plurality of second divided spaces larger than the first divided spaces, a second radio quality distribution in the predetermined space by using radio quality of each of the second divided spaces, changing the second divided spaces to third divided spaces smaller than the second divided spaces, based on first difference information indicating a difference in radio quality between the second radio quality distribution and the first radio quality distribution, and updating the second radio quality distribution to a third radio quality distribution by using radio quality of each of the third divided spaces.

A program according to a third aspect of the present disclosure causes a computer to execute generating, for a predetermined space formed from a plurality of first divided spaces, a first radio quality distribution in the predetermined space by using radio quality of each of the first divided spaces, and generating, for the predetermined space formed from a plurality of second divided spaces larger than the first divided spaces, a second radio quality distribution in the predetermined space by using radio quality of each of the second divided spaces, changing the second divided spaces to third divided spaces smaller than the second divided spaces, based on first difference information indicating a difference in radio quality between the second radio quality distribution and the first radio quality distribution, and updating the second radio quality distribution to a third radio quality distribution by using radio quality of each of the third divided spaces.

### Advantageous Effects of Invention

According to the present disclosure, an information processing device, an information processing method, and a non-transitory computer-readable medium capable of suppressing an increase in the amount of calculation can be provided.

### BRIEF DESCRIPTION OF DRAWINGS

FIG. 1 is a configuration diagram of an information processing device according to a first example embodiment.

FIG. 2 is a diagram illustrating a flow of a process of an information processing method according to the first example embodiment.

FIG. 3 is a configuration diagram of an information processing device according to a second example embodiment.

FIG. 4 is a diagram illustrating a reception power distribution according to the second example embodiment.

FIG. 5 is a diagram illustrating a reception power distribution according to the second example embodiment.

FIG. 6 is a diagram illustrating a reception power distribution according to the second example embodiment.

FIG. 7 is a diagram illustrating a reception power distribution according to the second example embodiment.

FIG. 8 is a diagram illustrating a flow of a process of updating a reception power distribution according to the second example embodiment.

FIG. 9 is a diagram explaining difference information between adjacent divided spaces according to the second example embodiment.

FIG. 10 is a configuration diagram of a communication system according to a third example embodiment.

FIG. 11 is a configuration diagram of the information processing device according to each example embodiment.

### EXAMPLE EMBODIMENT

### First Example Embodiment

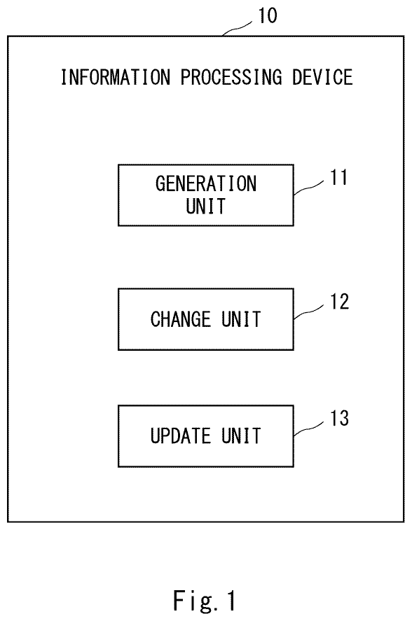

Example embodiments of the present disclosure will be described below with reference to the drawings. First, a configuration example of an information processing device 10 according to a first example embodiment will be described with reference to FIG. 1. The information processing device 10 may be a computer device that operates by a processor carrying out a program retained in a memory. The information processing device 10 may be, for example, a server device. The information processing device 10 may also be constituted with a computer device group formed from a plurality of computer devices connected via a network, a cable, or the like.

For a predetermined space formed from a plurality of first divided spaces, a generation unit 11 generates a first radio quality distribution in the predetermined space, using radio quality of each of the first divided spaces. The predetermined space may be a closed space partitioned by a wall or the like, or may be an open space without a partition by a wall or the like. In a case where the predetermined space is an open space, a position serving as a boundary between the inside of the predetermined space and the outside of the predetermined space may be determined.

The first divided space is a space after division in a case where the predetermined space is divided into a predetermined number of spaces. For example, the divided spaces may be spaces divided into a grid pattern in a case where the predetermined space is viewed from above, or may be spaces divided into shapes such as a rectangle, a circle, and a polygon. Each divided space may have the same size as or a different size from the other divided spaces. The same size may mean the same volume, or may mean the same area of a two-dimensional shape of the divided space in a case where the divided space is viewed from above.

The radio quality may be radio wave quality, communication quality, or the like, for example, and may be specifically reception power, electric field strength, throughput, or the like. The reception power is a power value at which a radio wave transmitted from a particular transmission source is received. The position of the transmission source may be determined in advance.

The radio quality distribution may be information indicating the radio quality in each divided space. For example, the radio quality distribution may be map information indicating the same radio quality using the same color on a map. Alternatively, the radio quality of a predetermined range may be indicated using the same color. The radio quality distribution may be generated as display information displayed on a display or the like. The radio quality indicated in the radio quality distribution may be, for example, radio quality at any location in the first divided space. The any location may be, for example, the position of a center in the first divided space. The position of the center in the first divided space may be, for example, a position of the center of the two-dimensional shape of the first divided space at a height determined in advance above the center, assuming the first divided space is viewed from above. Alternatively, the radio quality indicated in the radio distribution may be statistical information such as an average value, a maximum value, or a minimum value of the radio quality at two or more locations in the first divided space.

For the predetermined space formed from second divided spaces larger than the first divided spaces, the generation unit 11 generates a second radio quality distribution, using the second divided spaces. Since the second divided space is greater than the first division, the number of the second divided spaces is less than the number of the first divided spaces. Therefore, the number of radio qualities used in generating the second radio quality distribution is smaller than the number of radio qualities used in generating the first radio quality distribution. The number of divided spaces for which the radio quality needs to be specified in generating the second radio quality distribution is smaller than the number of divided spaces for which the radio quality needs to be specified in generating the first radio quality distribution.

The second radio quality distribution may be generated after a predetermined period of time has elapsed since the first radio quality distribution has been generated. Alternatively, the second radio quality distribution may be generated after a variation has occurred in arrangement of an object in the predetermined space after the first radio quality distribution has been generated. The occurrence of a variation in arrangement of an object may include a case where the position of the object has varied, a case where an object has been newly added in the predetermined space, or a case where an object has been excluded from the predetermined space.

The change unit 12 changes the second divided spaces to third divided spaces smaller than the second divided spaces, based on difference information indicating a difference in radio quality between the second radio quality distribution and the first radio quality distribution. In other words, the change unit 12 generates the third divided spaces by further dividing the second divided spaces. The difference in radio quality may be a difference in values indicated as radio quality. That is, a larger difference in radio quality indicates a larger variation in radio quality at the position indicated by the radio quality. The variation in radio quality may be caused by a variation in a propagation state of a radio wave or the like due to a variation in arrangement of an object in the predetermined space, for example. As the propagation state of a radio wave varies, events such as attenuation of the radio wave and amplification of the radio wave arise.

For example, in a case where the difference in radio quality is larger than a value determined in advance in the difference information, the second divided space associated with that radio quality may be further divided. The difference in radio quality may be an absolute value indicated by the value of the difference in radio quality. Alternatively, in adjacent second divided spaces, in a case where the difference between values indicated by pieces of difference information on the adjacent second divided spaces is larger than a value determined in advance, the divided spaces each may be further divided.

The update unit 13 updates the second radio quality distribution to the third radio quality distribution, using the radio quality of each of the third divided spaces. Specifically, the update unit 13 changes the second divided space in the second radio quality to the third divided space and generates the third radio quality distribution reflecting the radio quality in the third divided space.

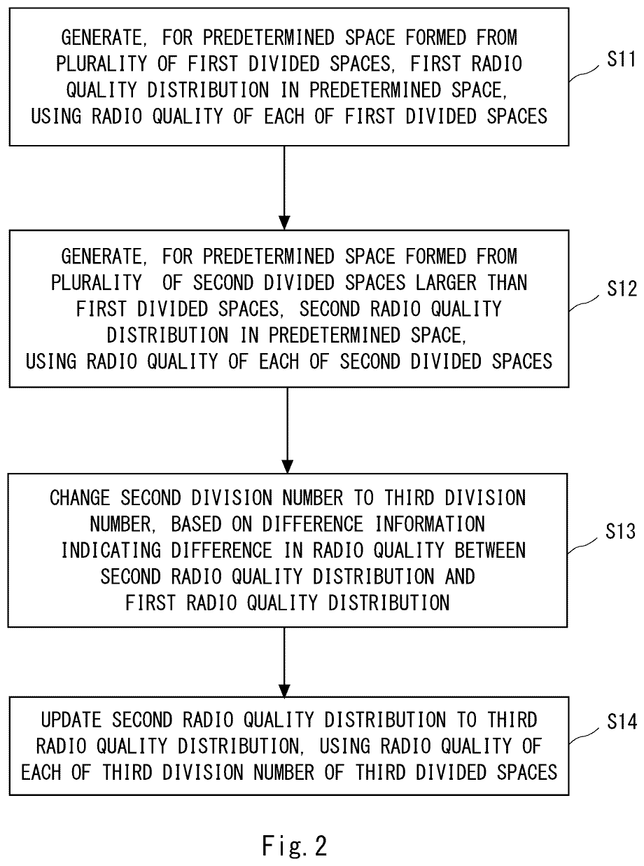

Subsequently, a flow of an information processing method executed by the information processing device 10 will be described with reference to FIG. 2.

First, for a predetermined space formed from a plurality of first divided spaces, the generation unit 11 generates the first radio quality distribution in the predetermined space, using the radio quality of each of the first divided spaces (S11). Next, for the predetermined space formed from a plurality of second divided spaces larger than the first divided spaces, the generation unit 11 generates the second radio quality distribution in the predetermined space, using the radio quality of each of the second divided spaces (S12).

Next, the change unit 12 changes the second divided spaces to third divided spaces smaller than the second divided spaces, based on difference information indicating a difference in radio quality between the second radio quality distribution and the first radio quality distribution (S13). Next, the update unit 13 updates the second radio quality distribution to the third radio quality distribution, using the radio quality of each of the third divided spaces (S14).

As described above, the information processing device 10 variably alters the number of divided spaces for indicating the radio quality in the radio quality distribution. Accordingly, in a case where the second radio quality distribution is generated after the first radio quality distribution is generated, the radio quality in the second divided spaces less in number than the first divided spaces used for the first radio quality distribution is specified. As a result, the number of radio qualities specified in generating the second radio quality distribution can be made smaller than that in generating the first radio quality distribution.

Furthermore, the information processing device 10 changes the second divided spaces to the third divided spaces smaller than the second divided spaces, based on the difference information. Accordingly, for example, in a case where a radio quality in a more detailed area is required, the space is further divided, and the radio quality is specified in each divided space, based on the difference information. Consequently, since the radio quality is finely specified in a space in which a variation in radio quality has occurred, the accuracy of the radio quality distribution can be improved.

### Second Example Embodiment

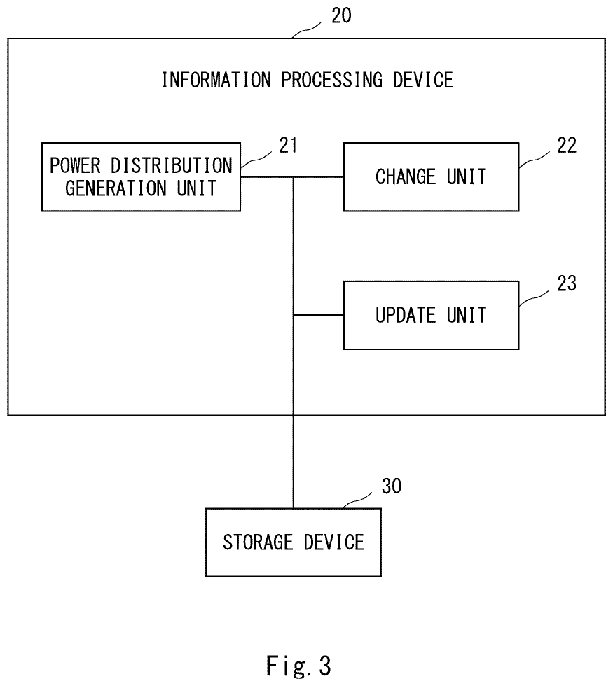

Subsequently, a configuration example of an information processing device 20 according to a second example embodiment will be described with reference to FIG. 3. The information processing device 20 includes a power distribution generation unit 21, a change unit 22, and an update unit 23. The power distribution generation unit 21 corresponds to the generation unit 11 in the information processing device 10. The change unit 22 corresponds to the change unit 12 in the information processing device 10. The update unit 23 corresponds to the update unit 13 in the information processing device 10.

The power distribution generation unit 21, the change unit 22, and the update unit 23 may be software or modules in which processing is executed by a processor executing a program retained in a memory. Alternatively, the power distribution generation unit 21, the change unit 22, and the update unit 23 may be hardware such as circuits or chips. In the following, functions and the like different from those of the information processing device 10 in FIG. 1 or detailed functions and the like relating to the information processing device 10 will be mainly described.

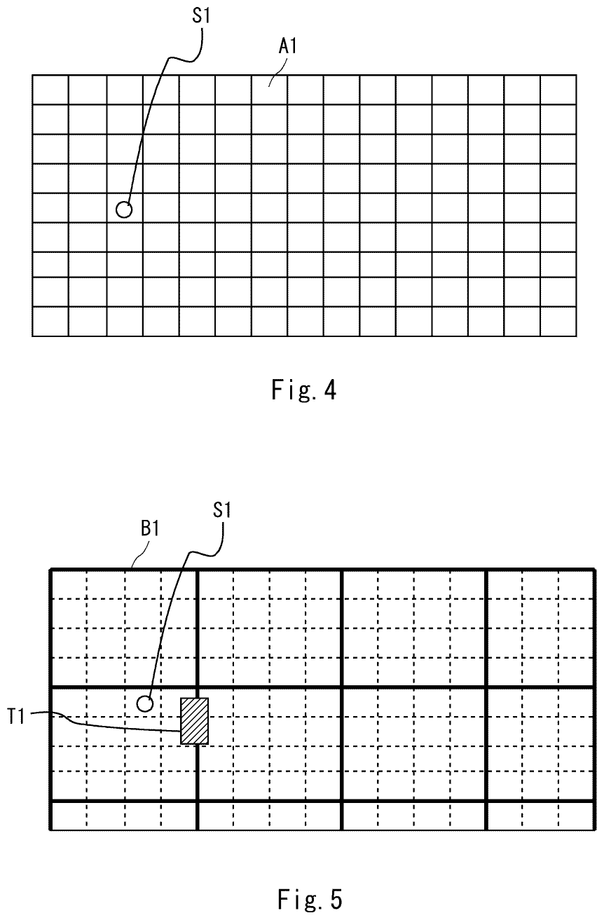

The power distribution generation unit 21 generates a reception power distribution as the radio quality distribution. Here, the reception power distribution will be described with reference to FIG. 4. FIG. 4 illustrates a diagram in a case where a predetermined space targeted for the reception power distribution is viewed from above. FIG. 4 illustrates that the predetermined space targeted for the reception power distribution is divided by using grid points. Specifically, it is illustrated that the predetermined space is formed from a plurality of divided spaces A1 surrounded by straight lines connecting four grid points. The circle existing in one divided space A1 indicates a transmission source S1 of radio waves. The radio waves radiated from the transmission source S1 propagate in the predetermined space. In a case where an obstacle exists in the predetermined space, the radio waves are reflected by the obstacle and further propagate in the predetermined space while being attenuated according to a propagation distance. The obstacle may be referred to as a shielding object, for example.

The power distribution generation unit 21 generates a reception power distribution indicating values of the reception power at the time of receiving the radio waves radiated from the transmission source in each of the divided spaces A1. For example, the reception power distribution may indicate the distribution of the reception power, using variations in color by using the same color at positions having the reception power of the same value. The same value is assumed to include a value within a predetermined range. The reception power in one divided space A1 may be assumed to have the same value. That is, the power distribution generation unit 21 may measure or estimate the value of the power for each divided space A1.

The power distribution generation unit 21 may generate the reception power distribution by simulating the reception power in each divided space A1. For example, the power distribution generation unit 21 may generate the reception power distribution by estimating the reception power in each divided space A1, using a ray tracing method. For example, the power distribution generation unit 21 may estimate the reception power in each divided space A1 by executing ray tracing using the position of an obstacle arranged in the predetermined space, the position of the transmission source S1, and the transmission power of the radio waves transmitted from the transmission source S1. The power distribution generation unit 21 may also use information regarding an angle of an antenna at the transmission source SI in executing ray tracing. The power distribution generation unit 21 may generate a power distribution in consideration of diffraction or the like of electromagnetic waves by executing ray tracing. The power distribution generation unit 21 may also generate a power distribution in consideration of diffraction or the like of electromagnetic waves by executing electromagnetic field analysis or the like.

Alternatively, the power distribution generation unit 21 may generate the reception power distribution, using the reception power actually measured in the predetermined space. For example, measurements in the predetermined space are performed at a plurality of measurement points. That is, measurements in the predetermined space are performed in a discrete space. Meanwhile, the reception power distribution needs to indicate the reception power in a continuous space or a more detailed discrete space. Therefore, the power distribution generation unit 21 may generate the reception power distribution in a continuous space or a more detailed discrete space by interpolating the reception power at a position where the actual measurement value does not exist, using a space interpolation method such as the inverse distance weighting (IDW) method or the Kriging method.

The reception power may be measured by, for example, a measuring device such as a sensor device. For example, a person carrying the measuring device may measure the reception power at a plurality of points while moving. Alternatively, a moving body to which the measuring device is attached may measure the reception power at a plurality of points while moving. The moving body may be an automatic guided vehicle (AGV). Alternatively, the moving body may be a flying object controlled using a wireless signal. The power distribution generation unit 21 may receive position information and the value of the reception power at the measurement point from the measuring device via a network.

The power distribution generation unit 21 saves the generated reception power distribution in a storage device 30. The saving may be rephrased as storing, recording, retaining, or the like. As illustrated in FIG. 3, the storage device 30 may be arranged outside the information processing device 20 to send and receive data to and from the information processing device 20 via a network, or may be attached via an external interface or the like of the information processing device 20. Alternatively, the storage device 30 may be equipped inside the information processing device 20. In a case where the reception power distribution is, for example, updated, the reception power distribution is read from the storage device 30, and the updated reception power distribution is saved in the storage device 30.

The change unit 22 changes the size of the divided space during the reception power distribution with the divided spaces A1 is updated. That is, the change unit 22 may change the division number in the predetermined space. The change unit 22 may change the size of the divided spaces after the reception power distribution using the divided spaces A1 has been generated and a predetermined period has elapsed. Alternatively, the change unit 22 may change the size of the divided spaces in a case where a change in arrangement of an obstacle in the predetermined space has occurred after the reception power distribution using the divided spaces A1 has been generated. The occurrence of a change in arrangement of an obstacle may include a case where an obstacle has been added to the predetermined space, a case where an obstacle has been removed, or a case where an obstacle has been moved in the predetermined space.

The change unit 22 may recognize that a change in arrangement of an obstacle has occurred by receiving information instructing to change the size of the divided spaces is input from an operator of the information processing device 20 who has recognized that a change in arrangement of an obstacle in the predetermined space has occurred. Alternatively, the change unit 22 may detect that a change in arrangement of an obstacle in the predetermined space has occurred, based on periodically received measurement results for the reception power in the predetermined space. For example, in a case where the difference between the value of the measurement result for the reception power and the value of the measurement result received last time is larger than a threshold value, the change unit 22 may verify that a change has occurred in arrangement of an obstacle in the predetermined space.

Alternatively, in a case where the arrangement of an obstacle is changed by simulation, the change unit 22 may detect that a change in arrangement of an obstacle has occurred, by accepting simulation information indicating the arrangement of the obstacle.

For example, the change unit 22 may define a space surrounded by the thick solid line in FIG. 5 as a divided space B1. That is, the change unit 22 may change the size of the divided space to the divided space B1 from the divided space A1. For example, the change unit 22 may change the size of the divided space by determining the length of one side of the divided space B1 as an integral multiple of one side of the divided space A1. The length of one side of the divided space B1 is not limited to an integral multiple of one side of the divided space A1, and for example, the length of one side of the divided space A1 may be multiplied by a predetermined value in such a way as to become longer than the length of one side of the divided space A1. FIG. 5 illustrates that an obstacle T1 has been added to the predetermined space. The power distribution generation unit 21 generates the reception power distribution using the divided spaces Bl in a similar manner to the reception power distribution using the divided spaces A1.

Since the size of the divided space Bl is larger than that of the divided space A1, the number of divided spaces B1 in the predetermined space is larger than that of the divided spaces A1. Therefore, the load relating to the generation of the reception power distribution using the divided spaces B1 is reduced as compared with the load relating to the generation of the reception power distribution using the divided spaces A1.

Here, in the following, the reception power distribution using the divided spaces A1 will be described as a reception power distribution A, and the reception power distribution using the divided spaces BI will be described as a reception power distribution B.

The change unit 22 generates difference information between the reception power distribution B and the reception power distribution A. Specifically, the change unit 22 computes a difference between the reception power of the divided space BI and the reception power of an area of the reception power distribution A corresponding to the divided space B1. The reception power of an area of the reception power distribution A corresponding to the divided space B1 may be assumed as, for example, the reception power of any one divided space A1 of a plurality of divided spaces A1 included in the area of the reception power distribution A corresponding to the divided space B1. That is, the reception power of any one divided space A1 may be regarded as the reception power of the area of the reception power distribution A corresponding to the divided space B1. The any one divided space A1 may be, for example, the divided space A1 closest to the center of the area of the reception power distribution A corresponding to the divided space B1. Alternatively, the reception power of the area of the reception power distribution A corresponding to the divided space B1 may be, for example, a statistic such as an average value, a maximum value, or a minimum value of the reception power of a plurality of divided spaces A1 included in the area of the reception power distribution A corresponding to the divided space B1.

For example, in a case where the length of one side of the divided space B1 is defined as an odd integer multiple of the length of one side of the divided space A1, there will be the divided space A1 including the center of the divided space B1. In this case, the divided space A1 including the center of the divided space B1 may be treated as the any one divided space A1.

A case where the difference between the reception power of the divided space B1 and the reception power of the area of the reception power distribution A corresponding to the divided space Bl exceeds a threshold value determined in advance indicates that the divided space B1 is a space where the change in position of the obstacle has large influence on fluctuations in the reception power. In other words, a case where the difference from the reception power of the area of the reception power distribution A corresponding to the divided space Bl is smaller than the threshold value determined in advance indicates that the divided space Bl is a space where the change in position of the obstacle has small influence on fluctuations in the reception power.

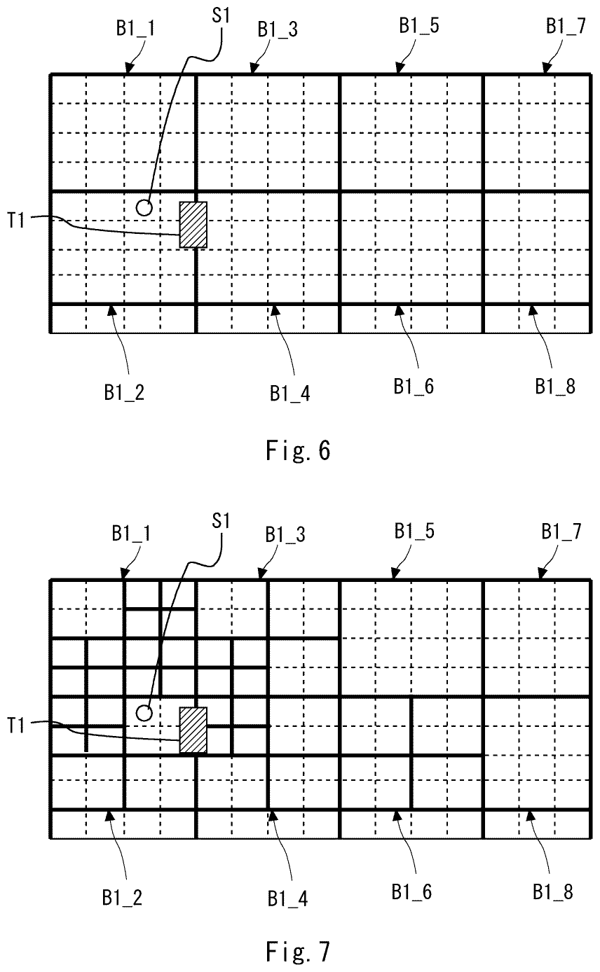

FIG. 6 illustrates identification information on the divided spaces B1. Differences from the reception power of areas of the reception power distribution A corresponding to divided spaces B1_x (x=1 to 8) are associated individually with the divided spaces B1_x. The difference between the reception power in the divided space B1_x (x=1 to 8) and the reception power in an area of the reception power distribution A corresponding to the divided space B1_x is defined as first difference information.

Here, the change unit 22 computes a difference between adjacent divided spaces in difference values of the first difference information on the adjacent divided spaces. The difference in the first difference information between the adjacent divided spaces is defined as second difference information.

For example, it is assumed that the value of the first difference information associated with the divided space B1_1 is determined as 4, the value of the first difference information associated with the divided space B1_2 is determined as 10, the value of the first difference information associated with the divided space B1_3 is determined as 3, the value of the first difference information associated with the divided space B1_4 is determined as 10, the value of the first difference information associated with the divided space B1_5 is determined as 3, the value of the first difference information associated with the divided space B1_6 is determined as 4, the value of the first difference information associated with the divided space B1_7 is determined as 3, and the value of the first difference information associated with the divided space B1_6 is determined as 3. The value of the first difference information may be a difference between the value of the reception power in the divided space B1 with decibel-milliwatt (dBm) as a unit and the value of the reception power in the area of the reception power distribution A corresponding to the divided space B1_x with dBm as a unit. The decibel-milliwatt (dBm) is an example of a unit, and for example, a unit such as watt (W: power) may be used. The value of the first difference information may be an absolute value, or a positive or negative number may be used.

It is assumed that the divided space B1_2 has a large difference in reception power before and after the appearance of the obstacle due to the influence of a reflected wave by the obstacle. It is also assumed that the divided space B1_4 has a large difference in reception power before and after the appearance of the obstacle due to the influence of the obstacle blocking the radio waves. It is assumed that the other divided spaces B1_y (y=1, 3, 5, 6, 7, and 8) are less affected than the divided spaces B1_2 and B1_4 in terms of fluctuations in the reception power due to the influence of the obstacle.

In this case, a value of the second difference information that is the difference between the first difference information in the divided space B1_1 and the first difference information in the divided space B1_2 has 6. Furthermore, a value of the second difference information that is the difference between the first difference information in the divided space B1_1 and the first difference information in the divided space B1_3 has 1. Here, in a case where the threshold value for the second difference information is assumed as 5, the second difference information between the divided spaces B1_1 and B1_2 has 6, the second difference information between the divided spaces B1_3 and B1_4 has 7, and the second difference information between the divided spaces B1_4 and B1_6 has 6, which exceed the threshold value.

FIG. 7 illustrates how the change unit 22 has further divided the divided spaces B1_1, B1_2, B1_3, B1_4, and B1_6 whose second difference information has exceeded the threshold value into four. After the divided spaces B1_1, B1_2, B1_3, B1_4, and B1_6 are further divided, the update unit 23 estimates the reception power in each of the divided spaces whose sizes have been changed.

The change unit 22 calculates the first difference information and the second difference information, using the divided spaces after the divided spaces B1_1, B1_2, B1_3, B1_4, and B1_6 have been divided into four. In a case where the second difference information exceeds the threshold value, the change unit 22 further divides the space after the division into four. FIG. 7 illustrates how the divided spaces B1_1, B1_2, B1_3, B1_4, and B1_6 have been divided and the spaces after the division have further been divided. The division number is not limited to four, and other numbers may be used.

The change unit 22 may repeat the division until the second difference information falls below the threshold value. In a case where the second difference information of the divided space after the division surpasses the threshold value, the change unit 22 may repeat the division until the divided space has the same size as the divided space A1. Alternatively, in a case where the second difference information of the divided space after the division surpasses the threshold value, the change unit 22 may repeat the division until the length of one side of the divided space reaches a value determined in advance.

In a case where the division by the change unit 22 is completed, the update unit 23 updates the reception power distribution B to a reception power distribution C having a plurality of divided spaces C in different sizes. The reception power distribution C has a larger number of divided spaces C than the number of divided spaces of the reception power distribution B. The number of divided spaces of the reception power distribution C may be smaller or larger than the number of divided spaces of the reception power distribution A. “The number of divided spaces is small” means that the divided spaces are coarse. “The number of divided spaces is large” means that the divided spaces are fine.

In a case where the number of divided spaces of the reception power distribution C is smaller than the number of divided spaces of the reception power distribution A, the information processing device 20 can also reduce the calculation cost as a whole while reducing the calculation cost for a location with less variation. On the other hand, in a case where the number of divided spaces of the reception power distribution C is larger than the number of divided spaces of the reception power distribution A, the information processing device 20 can calculate detailed variations by affording more calculation cost for a portion with more variation while reducing the calculation cost for a location with less variation. Thus, in any of the above cases, the information processing device 20 can achieve the effect of reducing the calculation cost for a location with less variation. An overall effect of the present disclosure is that the calculation cost for a location with less variation can be reduced. Since the information processing device 20 can reduce the calculation cost as a whole and then focus the calculation cost on a necessary place as in the effects described separately in the above cases, the information processing device 20 does not matter even if the calculation cost eventually increases as a whole.

In a case where the number of divided spaces of the reception power distribution C is larger than the number of divided spaces of the reception power distribution A, the power value of the divided space of the reception power distribution A relevant to the divided space of the reception power distribution C may be the power value of an area of the reception power distribution A including the position of the reception power distribution C. Alternatively, the power value of the divided space of the reception power distribution A relevant to the divided space of the reception power distribution C may be a statistic such as an average value of a plurality of divided spaces in the reception power distribution A included in the divided space of the reception power distribution C.

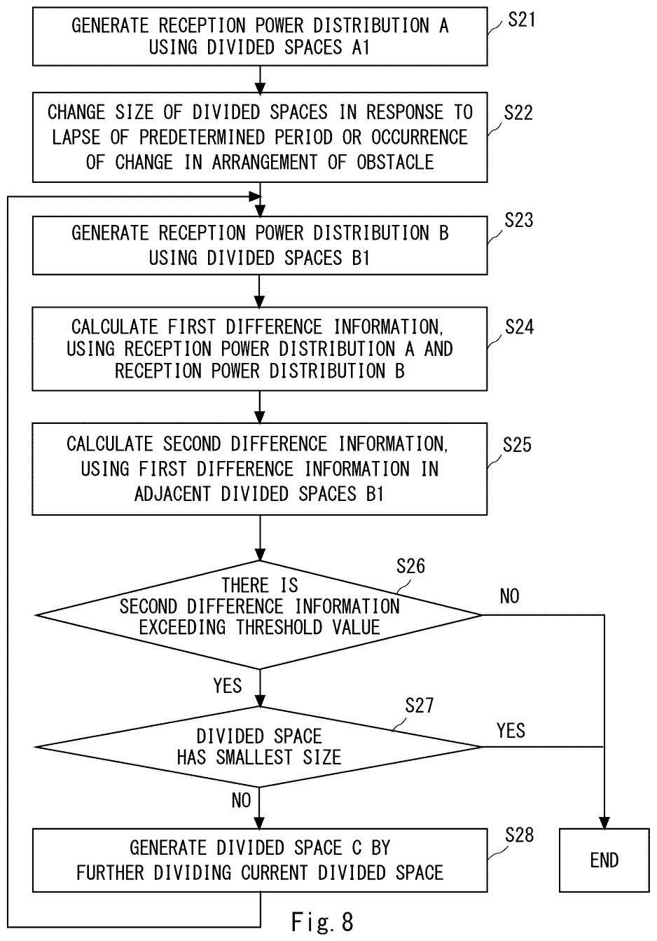

Subsequently, a flow of an update process for the reception power distribution in the information processing device 20 according to the second example embodiment will be described with reference to FIG. 8. First, the power distribution generation unit 21 generates the reception power distribution A indicating values of the reception power at the time of receiving the radio waves radiated from the transmission source in each of the divided spaces A1 (S21). For example, the power distribution generation unit 21 may generate the reception power distribution by estimating the reception power in each divided space A1, using the ray tracing method. Alternatively, the power distribution generation unit 21 may generate the reception power distribution, using the reception power actually measured in the predetermined space and the reception power interpolated using the IDW method or the Kriging method.

Next, the change unit 22 changes the size of the divided spaces in a case where a predetermined period has elapsed from the generation of the reception power distribution A or in a case where a change in arrangement of an obstacle in the predetermined space has occurred (S22). For example, the change unit 22 may determine a new divided space B1 including a plurality of divided spaces A1. That is, the change unit 22 may determine the divided space B1 larger than the current divided space A1.

Next, the power distribution generation unit 21 generates the reception power distribution B indicating values of the reception power at the time of receiving the radio waves radiated from the transmission source in the divided spaces B1 (S23). Similarly to the case of generating the reception power distribution A, the power distribution generation unit 21 may generate the reception power distribution, using the ray tracing method, the IDW method or the Kriging method, or the like.

Next, the change unit 22 calculates the first difference information, using the reception power distribution A and the reception power distribution B (S24).

The change unit 22 computes a difference between the reception power of the divided space B1 and the reception power of an area of the reception power distribution A corresponding to the divided space B1.

Next, the change unit 22 calculates the second difference information, using the first difference information in each of adjacent divided spaces B1 (S25).

Next, the change unit 22 verifies whether there is second difference information exceeding the threshold value (S26). The fact that the second difference information exceeds the threshold value indicates that there is a high possibility that the boundary between an area with large fluctuations in the reception power and an area with small fluctuations in the reception power due to the influence of an obstacle is included in each of the adjacent divided spaces B1 used in calculating the second difference information.

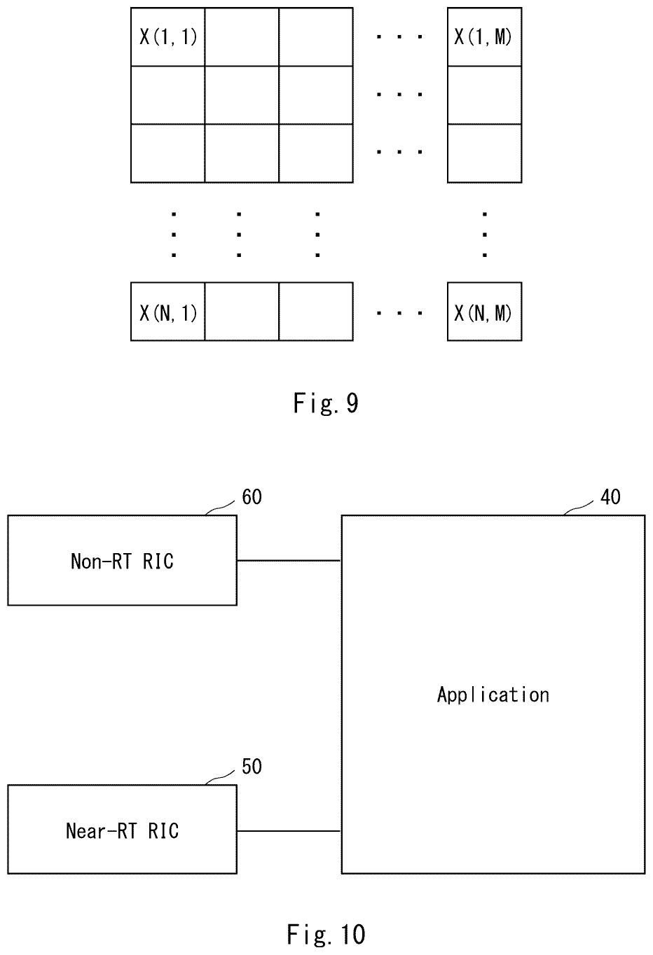

Here, the second difference information will be described with reference to FIG. 9. FIG. 9 illustrates a predetermined space formed from the divided spaces B1. Each of the divided spaces B1 is represented as X (n, m). A positive integer equal to or more than one but equal to or less than N is denoted by n, and a positive integer equal to or more than one but equal to or less than M is denoted by m. The letter n is used as a code for identifying a row, and the letter m is used as a code for identifying a column. N denotes a maximum value of the rows of the divided spaces BI represented in a grid pattern, and M denotes a maximum value of columns of the divided spaces B1 represented in a grid pattern.

The change unit 22 verifies whether X (n, m−1)−X (n, m) exceeds the threshold value. The change unit 22 further verifies whether X (n−1, m)−X (n, m) exceeds the threshold value.

Returning to FIG. 8, upon verifying that there is second difference information exceeding the threshold value, the change unit 22 verifies whether the current divided space has the size of a smallest divided space (S27). The smallest divided space may be, for example, the divided space A1.

Upon verifying that the current divided space does not have the size of the smallest divided space, the change unit 22 further divides the current divided space to generate, for example, a divided space C1 (S28). After the divided space C1 is determined by the change unit 22, the processes in step S23 and the subsequent steps are repeated. Here, in a case where the processes in step S23 and the subsequent steps are repeated, it is assumed that the reception power distribution C using the divided space C1 is generated in step S23. The generation of the power distribution repeatedly carried out in step S23 may be executed in the update unit 23. In step S24, it is assumed that the first difference information is calculated using the reception power distribution B and the reception power distribution C. In step S25, the second difference information is calculated using the first difference information in the adjacent divided spaces C1. It is assumed that X (n, m), X (n, m+1), and X (n+1, m) in step S26 each denote a divided space further divided from the divided space B1.

In this manner, in a case where the processes in step S23 and the subsequent steps are repeated, a new reception power distribution is generated using a new divided space generated in step S28. In step S23, every time the power distribution generation unit 21 generates the reception power distribution, the generated reception power distribution may be output to a display unit or the like of the information processing device 20.

In a case where there is no second difference information exceeding the threshold value in step S26, or in a case where the divided space has the smallest size in step S27, the process ends.

As described above, in a case where the second difference information that is a difference in the first difference information between adjacent divided spaces is larger than the threshold value, the information processing device 20 according to the second example embodiment divides each of the adjacent divided spaces.

The change unit 22 repeats the division of the divided space until the second difference information between the adjacent divided spaces falls below the threshold value. The reception power distribution generated as a result can accurately indicate the boundary between an area where the magnitude of the reception power greatly fluctuates due to the influence of an obstacle and an area where fluctuations in the magnitude of the reception power due to the influence of the obstacle are small.

By stopping repeating the division at the time once the size of the divided space coincides with the divided space A1, the reception power distribution can be generated using the number of divided spaces smaller than the number of divided spaces A1 used in generating the reception power distribution A1. As a result, in a case where the reception power distribution A is updated in order to reflect the influence of an obstacle, it is sufficient to estimate the reception power of a smaller number of divided spaces than the number of divided spaces A1, and therefore, the reception power A can be updated with a load smaller than the load for generating the reception power A.

### Third Example Embodiment

Subsequently, a configuration example of a communication system according to a third example embodiment will be described with reference to FIG. 10. In the third example embodiment, a configuration example of a communication system in a case where the processes in the information processing device 20 described in the second example embodiment are applied to an open-radio access network (O-RAN) radio access network intelligent controller (RIC) is illustrated. The O-RAN RIC is a logical node that optimizes a RAN element or RAN resource stipulated in the O-RAN Alliance.

The communication system in FIG. 10 includes an application 40, a Near-real time (Near-RT) RIC 50, and a Non-real time (Non-RT) RIC 60. The application 40 may be, for example, an application server or an application as software equipped in the information processing device. The Near-RT RIC 50 is a logical node that performs quasi-real-time control and optimization of the RAN element or the RAN resource.

For example, the power distribution generation unit 21 in FIG. 3 may be executed in the application 40. The change unit 22 and the update unit 23 may be executed in either the Near-RT RIC 50 or the Non-RT RIC 60.

For example, the generation of the reception power distribution C updated using the divided spaces C1 generated first from the divided spaces B1 in step S28 of FIG. 8 may be executed in the Near-RT RIC 50. The update process thereafter for the reception power distribution with higher accuracy repeated until the divided space has the smallest size may be executed in the Non-RT RIC 60.

Furthermore, the application 40 may output simulation information simulating the arrangement of an obstacle to the Near-RT RIC 50 or the Non-RT RIC 60 that executes the process in the change unit 22.

As described above, by distributing and arranging the processes executed in the information processing device 20 in FIG. 3, the processes may be applied to the communication system stipulated in the O-RAN Alliance.

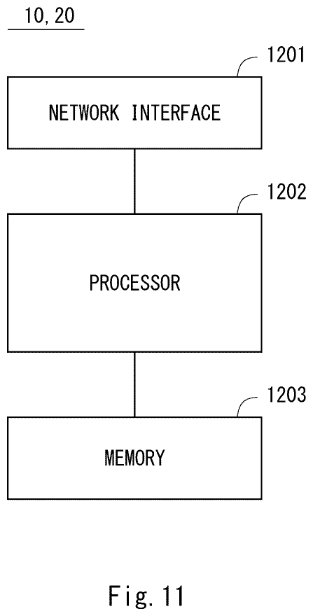

FIG. 11 is a block diagram illustrating a configuration example of the information processing devices 10 and 20 (hereinafter, referred to as the information processing device 10 and the like). Referring to FIG. 11, the information processing device 10 and the like include a network interface 1201, a processor 1202, and a memory 1203. The network interface 1201 is used to communicate with a network node (e.g., eNB, MME, or P-GW). The network interface 1201 may include, for example, a network interface card (NIC) conforming to IEEE 802.3 series. Here, the eNB represents an evolved node B, the MME represents a mobility management entity, and the P-GW represents a packet data network gateway. The IEEE represents the Institute of Electrical and Electronics Engineers.

The processor 1202 reads and executes software (computer program) from the memory 1203 to perform the processes in the information processing device 10 and the like described above with reference to the flowcharts in the example embodiments. The processor 1202 may be, for example, a microprocessor, a micro processing unit (MPU), or a central processing unit (CPU). The processor 1202 may include a plurality of processors.

The memory 1203 is formed from a combination of a volatile memory and a nonvolatile memory. The memory 1203 may include a storage arranged away from the processor 1202. In this case, the processor 1202 may access the memory 1203 via an input/output (I/O) interface (not illustrated).

In the example in FIG. 11, the memory 1203 is used to store a group of software modules. The processor 1202 can perform the processes of the information processing device 10 and the like described above in the example embodiments by reading and executing this group of software modules from the memory 1203.

As described with reference to FIG. 11, each of the processors included in the information processing device 10 and the like in the above-described example embodiments executes one or more programs including a group of commands for causing a computer to perform the algorithms described with reference to the drawings.

In the example described above, the program includes a group of commands (or software codes) for causing a computer to perform one or more functions described in the example embodiments in a case where the program is read by the computer. The program may be retained in a non-transitory computer-readable medium or a tangible storage medium. By way of example and not limitation, a computer-readable medium or tangible storage medium includes a random-access memory (RAM), a read-only memory (ROM), a flash memory, a solid-state drive (SSD) or other memory techniques, a compact disc read-only memory (CD-ROM), a digital versatile disc (DVD), a Blu-ray (registered trademark) disc, or other optical disc storages, and a magnetic cassette, a magnetic tape, a magnetic disk storage, or other magnetic storage devices. The program may be sent on a transitory computer-readable medium or a communication medium. By way of example and not limitation, the transitory computer-readable medium or the communication medium includes electrical, optical, acoustic, or any other form of propagated signals.

Note that the technical ideas of the present disclosure are not limited to the above example embodiments and can be appropriately changed without departing from the scope.

Some or all of the above-described example embodiments may also be described as the following Supplementary Notes, but are not limited to the following.

### (Supplementary Note 1)

An information processing device including:
a generation unit for generating, for a predetermined space formed from a plurality of first divided spaces, a first radio quality distribution in the predetermined space by using radio quality of each of the first divided spaces, and generating, for the predetermined space formed from a plurality of second divided spaces larger than the first divided spaces, a second radio quality distribution in the predetermined space by using radio quality of each of the second divided spaces;
a change unit for changing the second divided spaces to third divided spaces smaller than the second divided spaces, based on first difference information indicating a difference in radio quality between the second radio quality distribution and the first radio quality distribution; and
an update unit for updating the second radio quality distribution to a third radio quality distribution by using radio quality of each of the third divided spaces.
   (supplementary Note 2)

The information processing device according to Supplementary Note 1, in which the first difference information indicates a difference between radio quality in one of the second divided spaces and radio quality in an area of the first radio quality distribution corresponding to the one of the second divided spaces.

### (Supplementary Note 3)

The information processing device according to Supplementary Note 2, in which radio quality in an area of the first radio quality distribution corresponding to one of the second divided spaces is radio quality in one of the first divided spaces including a center position of the one of the second divided spaces.

### (Supplementary Note 4)

The information processing device according to Supplementary Note 2, in which radio quality in an area of the first radio quality distribution corresponding to one of the second divided spaces is statistical information on radio quality in each of the first divided spaces included in the one of the second divided spaces.

### (Supplementary Note 5)

The information processing device according to Supplementary Note 4, in which radio quality in an area of the first radio quality distribution corresponding to one of the second divided spaces is an average value, a maximum value, or a minimum value of radio quality in each of the first divided spaces included in the one of the second divided spaces.

### (Supplementary Note 6)

The information processing device according to any one of Supplementary Notes 1 to 5, in which
a difference between pieces of first difference information regarding adjacent ones of the second divided spaces is defined as second difference information, and
the change unit
divides the adjacent ones of the second divided spaces in a case where the second difference information exceeds a threshold value.

### (Supplementary Note 7)

The information processing device according to any one of Supplementary Notes 1 to 6, in which
the change unit
designates a size of the second divided spaces in a case where it is detected that a variation has occurred in arrangement of an object included in the predetermined space, and
the generation unit
generates the first radio quality distribution before the variation in arrangement of the object has occurred and the second radio quality distribution after the variation in arrangement of the object has occurred.

### (Supplementary Note 8)

An information processing method including:
generating, for a predetermined space formed from a plurality of first divided spaces, a first radio quality distribution in the predetermined space by using radio quality of each of the first divided spaces;

generating, for the predetermined space formed from a plurality of second divided spaces larger than the first divided spaces, a second radio quality distribution in the predetermined space by using radio quality of each of the second divided spaces;
changing the second divided spaces to third divided spaces smaller than the second divided spaces, based on first difference information indicating a difference in radio quality between the second radio quality distribution and the first radio quality distribution; and
updating the second radio quality distribution to a third radio quality distribution by using radio quality of each of the third divided spaces.

### (Supplementary Note 9)

The information processing method according to Supplementary Note 8,further including generating the second radio quality distribution after it is detected that a variation has occurred in arrangement of an object included in the predetermined space.

### (Supplementary Note 10)

A program for causing a computer to execute:
generating, for a predetermined space formed from a plurality of first divided spaces, a first radio quality distribution in the predetermined space by using radio quality of each of the first divided spaces;
generating, for the predetermined space formed from a plurality of second divided spaces larger than the first divided spaces, a second radio quality distribution in the predetermined space by using radio quality of each of the second divided spaces;
changing the second divided spaces to third divided spaces smaller than the second divided spaces, based on first difference information indicating a difference in radio quality between the second radio quality distribution and the first radio quality distribution; and
updating the second radio quality distribution to a third radio quality distribution by using radio quality of each of the third divided spaces.
10 information processing device
11 generation unit
12 change unit
13 update unit
20 information processing device
21 power distribution generation unit
22 change unit
23 update unit
30 storage device
40 application
50 Near-RT RIC
60 Non-RT RIC

What is claimed is:

1. An information processing device comprising:
at least one memory storing instructions; and
at least one processor configured to execute the instructions to,
generate, for a predetermined space formed from a plurality of first divided spaces, a first radio quality distribution in the predetermined space by using radio quality of each of the first divided spaces, and generating, for the predetermined space formed from a plurality of second divided spaces larger than the first divided spaces, a second radio quality distribution in the predetermined space by using radio quality of each of the second divided spaces;
change the second divided spaces to third divided spaces smaller than the second divided spaces, based on first difference information indicating a difference in radio quality between the second radio quality distribution and the first radio quality distribution; and
update the second radio quality distribution to a third radio quality distribution by using radio quality of each of the third divided spaces.

2. The information processing device according to claim 1, wherein the at least one processor is further configured to execute the instructions to indicate a difference between radio quality in one of the second divided spaces and radio quality in an area of the first radio quality distribution corresponding to the one of the second divided spaces.

3. The information processing device according to claim 2, wherein radio quality in an area of the first radio quality distribution corresponding to one of the second divided spaces is radio quality in one of the first divided spaces including a center position of the one of the second divided spaces.

4. The information processing device according to claim 2, wherein radio quality in an area of the first radio quality distribution corresponding to one of the second divided spaces is statistical information on radio quality in each of the first divided spaces included in the one of the second divided spaces.

5. The information processing device according to claim 4, wherein radio quality in an area of the first radio quality distribution corresponding to one of the second divided spaces is an average value, a maximum value, or a minimum value of radio quality in each of the first divided spaces included in the one of the second divided spaces.

6. The information processing device according to claim 1, wherein
a difference between pieces of first difference information regarding adjacent ones of the second divided spaces is defined as second difference information, and
the at least one processor is further configured to execute the instructions to
divide the adjacent ones of the second divided spaces in a case where the second difference information exceeds a threshold value.

7. The information processing device according to claim 1, wherein
the at least one processor is further configured to execute the instructions to
designate a size of the second divided spaces in a case where it is detected that a variation has occurred in arrangement of an object included in the predetermined space, and
generate the first radio quality distribution before the variation in arrangement of the object has occurred and the second radio quality distribution after the variation in arrangement of the object has occurred.

8. An information processing method comprising:
generating, for a predetermined space formed from a plurality of first divided spaces, a first radio quality distribution in the predetermined space by using radio quality of each of the first divided spaces;
generating, for the predetermined space formed from a plurality of second divided spaces larger than the first divided spaces, a second radio quality distribution in the predetermined space by using radio quality of each of the second divided spaces;
changing the second divided spaces to third divided spaces smaller than the second divided spaces, based on first difference information indicating a difference in radio quality between the second radio quality distribution and the first radio quality distribution; and
updating the second radio quality distribution to a third radio quality distribution by using radio quality of each of the third divided spaces.

9. The information processing method according to claim 8, further comprising generating the second radio quality distribution after it is detected that a variation has occurred in arrangement of an object included in the predetermined space.

10. A non-transitory computer-readable medium storing a program for causing a computer to execute:
generating, for a predetermined space formed from a plurality of first divided spaces, a first radio quality distribution in the predetermined space by using radio quality of each of the first divided spaces;
generating, for the predetermined space formed from a plurality of second divided spaces larger than the first divided spaces, a second radio quality distribution in the predetermined space by using radio quality of each of the second divided spaces;
changing the second divided spaces to third divided spaces smaller than the second divided spaces, based on first difference information indicating a difference in radio quality between the second radio quality distribution and the first radio quality distribution; and
updating the second radio quality distribution to a third radio quality distribution by using radio quality of each of the third divided spaces.
